(19) United States
(12) Patent Application Publication
(10) Pub. No.: US 2002/0077770 A1
(43) Pub. Date: Jun. 20, 2002

(54) Method and system for identifying and evaluating runout limits of rotational components

(76) Inventors: Christopher A. Kaminski, Niskayuna, NY (US); Blake W. Wilson, Scotia, NY (US)

Correspondence Address: PERKINS COIE LLP, PATENT-SEA, P.O. BOX 1247, SEATTLE, WA, 98111-1247, US

(21) Appl. No.: 09/742,665

(22) Filed: Dec. 20, 2000

(51) Int. Cl. G06F 15/00

(52) U.S. Cl. 702/155

(57) ABSTRACT

Methods and systems for evaluating individual components of total indicated runout readings. The individual components include the once-per-revolution (eccentricity), twice-per-revolution (ellipticity), and thrice-per-revolution runout components. In one embodiment, the method establishes a screening value for a total indicated runout reading. If a measured total indicated runout of a circular cross-section in question is less than this screening value, then the cross-section is acceptable. Conversely, if the measured total indicated runout exceeds the screening value, then the circular cross-section may or may not be acceptable. Further evaluation of the cross section can include recording runout readings at different locations around the circular cross-section, and fitting these runout readings to a regression equation. The magnitude of the individual runout components can then be calculated using constants derived from this regression equation.

### TECHNICAL FIELD

The described technology relates to dimensional inspection of rotational components, and more particularly, to identifying and evaluating runout limits of rotational turbine parts.

### BACKGROUND

Rotational components, such as cylindrical shafts, flywheels, and rotating blade assemblies, are used in a multitude of different mechanical applications. A common feature associated with many rotational components is that most usually have one or more critical cylindrical surfaces. A critical cylindrical surface can be defined as one in which certain dimensional characteristics should be within specified tolerances if the component is to function properly. Two important dimensional characteristics that are often specified for critical cylindrical surfaces are the profile of the surface and the axial alignment of the surface. The term “axial alignment” refers to the alignment between the component's centroidal and rotational axes.

The profile of a critical cylindrical surface may be important to ensure that mating parts which install onto or around the surface fit properly, especially where a close tolerance fit may be essential to the component's function. A rotating shaft in a journal bearing is one such example. Similarly, the axial alignment of a critical cylindrical surface may be important to avoid the dynamic imbalances and attendant high vibration that accompanies axial misalignment at high rotational speeds. Dimensional requirements for the profile and axial alignment of a cylindrical surface will usually be dictated by the rotational component's particular application, and post-manufacture inspections of the component will generally be performed to ensure that the cylindrical surface meets these requirements.

FIG. 1A is an isometric view of a representative rotational component, a cylindrical shaft 100, undergoing a post-manufacture dimensional inspection. The profile of a cylindrical surface 101 on the cylindrical shaft 100 is being measured by a dial indicator 110 at a station 106. As the cylindrical shaft 100 rotates through 360° about a rotational axis 102, a needle 114 on the dial indicator 110 indicates the amount by which the profile of the surface 101 varies from a theoretically perfect circular profile rotating about its centroidal axis. The extreme positions of the needle 114 define the total indicated runout (TIR) 112 of the cylindrical surface 101 at the station 106.

FIG. 1B illustrates a graph 121 of a representative runout plot 126 of the cylindrical surface 101. The runout is plotted as a function of the angle of rotation of the cylindrical shaft 100. A vertical axis 122 represents the measured runout, and a horizontal axis 124 represents the angular location on the shaft 100 corresponding to the measured runout. One revolution of the cylindrical shaft 100 is equivalent to the interval between 0 and 360° on the horizontal axis 124. The TIR 112 at station 106 is equivalent to the difference between the maximum and minimum measured runouts corresponding to the extreme positions of the needle 114 (FIG. 1A).

In a typical dimensional inspection, if the TIR 112 exceeds a specified engineering requirement, the cylindrical shaft 100 will be deemed unacceptable and rejected accordingly. Rejection of discrepant components result in a waste of raw materials and other important resources. This is especially true for high-speed rotational components where a significant investment in raw materials, tooling, and manufacturing time is often required to manufacture components with the degree of precision dictated by such applications. A method of inspecting rotational components that results in reducing the rate of rejection, would therefore be desirable.

### BRIEF DESCRIPTION OF THE DRAWINGS

FIG. 1A is an isometric view of a cylindrical shaft undergoing a dimensional inspection.

FIG. 1B is a graphical illustration of the runout of the cylindrical shaft of FIG. 1A as a function of angular rotation in accordance with an embodiment.

FIG. 2A is a side view of a cylindrical shaft undergoing a dimensional inspection illustrating a once-per-revolution component of a total indicated runout in accordance with an embodiment.

FIG. 2B is a cross-sectional view taken substantially along line 2B-2B in FIG. 2A illustrating the once-per-revolution component of the total indicated runout in accordance with an embodiment.

FIG. 2C is a graphical illustration of the once-per-revolution runout component of the cylindrical shaft of FIG. 2A in accordance with an embodiment.

FIG. 3A is a side view of a cylindrical shaft undergoing a dimensional inspection illustrating a twice-per-revolution component of a total indicated runout in accordance with an embodiment.

FIG. 3B is a cross-sectional view taken substantially along line 3B-3B in FIG. 3A illustrating the twice-per-revolution component of the total indicated runout in accordance with an embodiment.

FIG. 3C is a graphical illustration of the twice-per-revolution runout component of the cylindrical shaft of FIG. 3A in accordance with an embodiment.

FIGS. 4A and 4B together illustrate a flow diagram of a routine for identifying and evaluating individual components of a total indicated runout in accordance with an embodiment.

FIG. 5 is a table of representative allowable limits for selected total indicated runout components in accordance with an embodiment.

FIG. 6 illustrates a display description for entering data used to determine the components of a total indicated runout in accordance with an embodiment.

FIG. 7 illustrates a display description for displaying determined total indicated runout components in accordance with an embodiment.

### DETAILED DESCRIPTION

The present disclosure provides a method and system for identifying and evaluating individual components of total indicated runout readings for rotational or other cylindrical parts used in various types of mechanical applications. The method recognizes that a total indicated runout (TIR) reading of a particular surface is often the result of the combined effects of more than one individual runout component. For example, the TIR may be composed of a once-per-revolution component (also referred to as an eccentricity component), a twice-per-revolution component (also referred to as an ellipticity component), and a thrice-per-revolution component. The method further recognizes that each of these individual runout components will have its own allowable runout limit, depending on the particular engineering requirements of the surface in question. Accordingly, a TIR reading that happens to exceed the allowable limit of one of its individual runout components may nevertheless be acceptable, as the portion of the TIR actually attributable to that individual runout component may still be well within its allowable limit. Based on the foregoing premise, the inspection method of the present disclosure breaks down the TIR into its individual components, and compares each individual component to its own allowable runout limit, before making a determination as to the acceptability of a particular part.

In contrast to the method disclosed herein, some conventional inspection methods do not break the TIR down into its individual components. Instead, the TIR is simply measured and compared to an allowable TIR limit that will ensure that the rotational component will function properly in all respects. In the absence of breaking the TIR down into its individual components, these conventional inspection methods require that the allowable TIR limit be set to an over-conservatively tight tolerance, essentially equivalent to the lowest runout limit that could be tolerated for any of the individual runout components. As a result, such conventional inspection methods often result in the rejection of rotational components that, in fact, may be perfectly adequate for their intended purpose.

In one embodiment, the method establishes a screening value for the TIR. If the measured TIR of the rotational component under inspection is less than this screening value, then the component is automatically deemed acceptable. Conversely, if the measured TIR of the rotational component happens to be greater than the screening value, then the component may or may not be acceptable, and further analysis and evaluation is required. In such a case, indicated runout readings are recorded at a plurality of different points around the cylindrical surface of the rotational component under inspection. The data comprised of the recorded runout readings is then fit to a harmonic equation, or alternatively, a Fast Fourier Transform. Using constants derived from this harmonic equation, the magnitude of the individual runout components can be calculated. These individual runout components are then compared to their respective allowable limits. If each of the individual runout components are within their respective allowable limits, then the part is deemed acceptable for use. Conversely, if the individual runout components exceed their respective allowable limits, then the part is accordingly deemed unacceptable for use.

The following disclosure describes embodiments with reference to a representative rotational component, in the form of a rotating cylindrical shaft. Those skilled in the relevant art will readily appreciate that the discussion is equally applicable to any rotational component, and indeed, can even be applied to translational or stationary cylindrical components where the TIR is concerned. Further, certain embodiments will also be described in the general context of computer-executable instructions, such as routines executed by a general purpose computer. Those skilled in the relevant art will also appreciate that embodiments can be practiced with other computer systems, or alternatively, with manual computations. Although the following description provides specific details for a thorough understanding of, and an enabling description for, several embodiments, one of skill in the art, however, will understand that these embodiments can be practiced without these details. In other instances, well-known structures and functions related to the relevant art, for example, computer executable instructions and corresponding computer systems, have not been shown or described in detail to avoid unnecessarily obscuring the description of the embodiments.

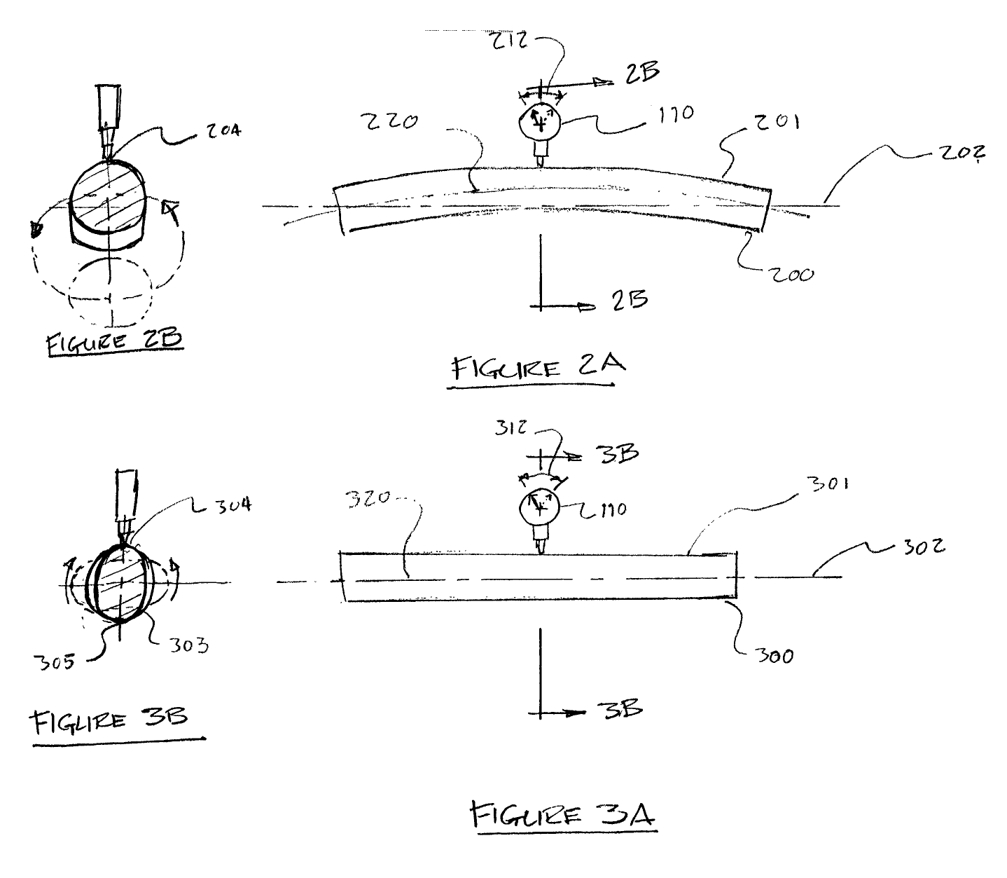

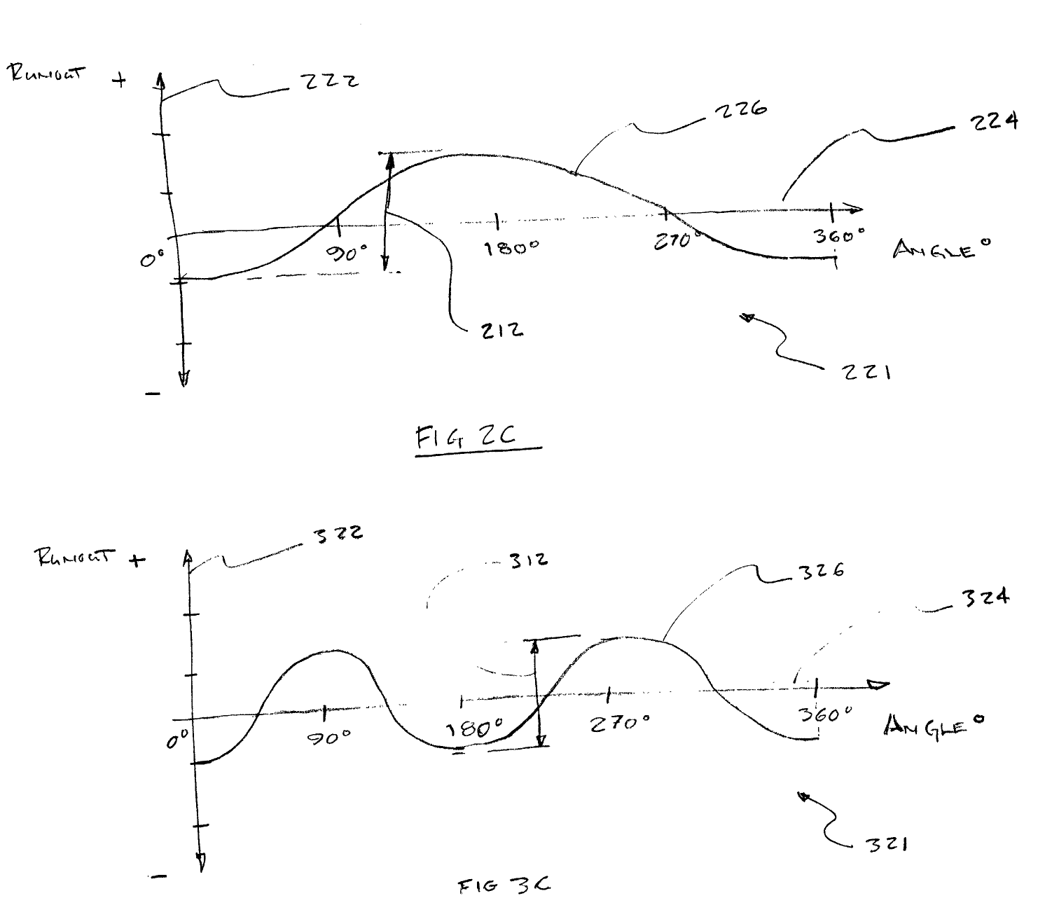

FIG. 2A is a side view of a cylindrical shaft 200 illustrating a once-per-revolution (eccentricity) component of a TIR in accordance with an embodiment. The cylindrical shaft 200 is undergoing a dimensional inspection, and has a centroidal axis 220 and a rotational axis 202. The dial indicator 110 indicates a TIR 212 as the cylindrical shaft 200 rotates through 360° about the rotational axis 202. Assuming, for the purpose of illustration, that a cylindrical surface 201 of the cylindrical shaft 200 has a perfectly circular profile, the total magnitude of the TIR 212 will be completely attributable to the misalignment between the centroidal axis 220 and the rotational axis 202. This contribution to the TIR can be referred to as the once-per-revolution or eccentricity component.

FIG. 2B is a cross-sectional view taken substantially along line 2B-2B in FIG. 2A, and illustrates why the eccentricity component of the TIR can be identified as a once-per-revolution component of the TIR. As the cylindrical shaft 200 rotates through one revolution of 3600, the peak in the measured runout, identified by a location 204, will occur only once per revolution.

FIG. 2C is a graph 221 illustrating a plot 226 of a once-per-revolution runout component of the cylindrical shaft 200, in accordance with an embodiment. A vertical axis 222 represents the measured runout, and a horizontal axis 224 represents the angle of rotation of the cylindrical shaft 200. The plot 226 graphically illustrates the runout as a function of the angle of rotation. A single revolution of the cylindrical shaft 200 is equivalent to the interval between 0 and 360° on the horizontal axis 224. The difference between the maximum and minimum runout measurements is equivalent to the TIR 212. As can be seen from the shape of the plot 226, the eccentricity component's contribution to the TIR 212 occurs only once per revolution.

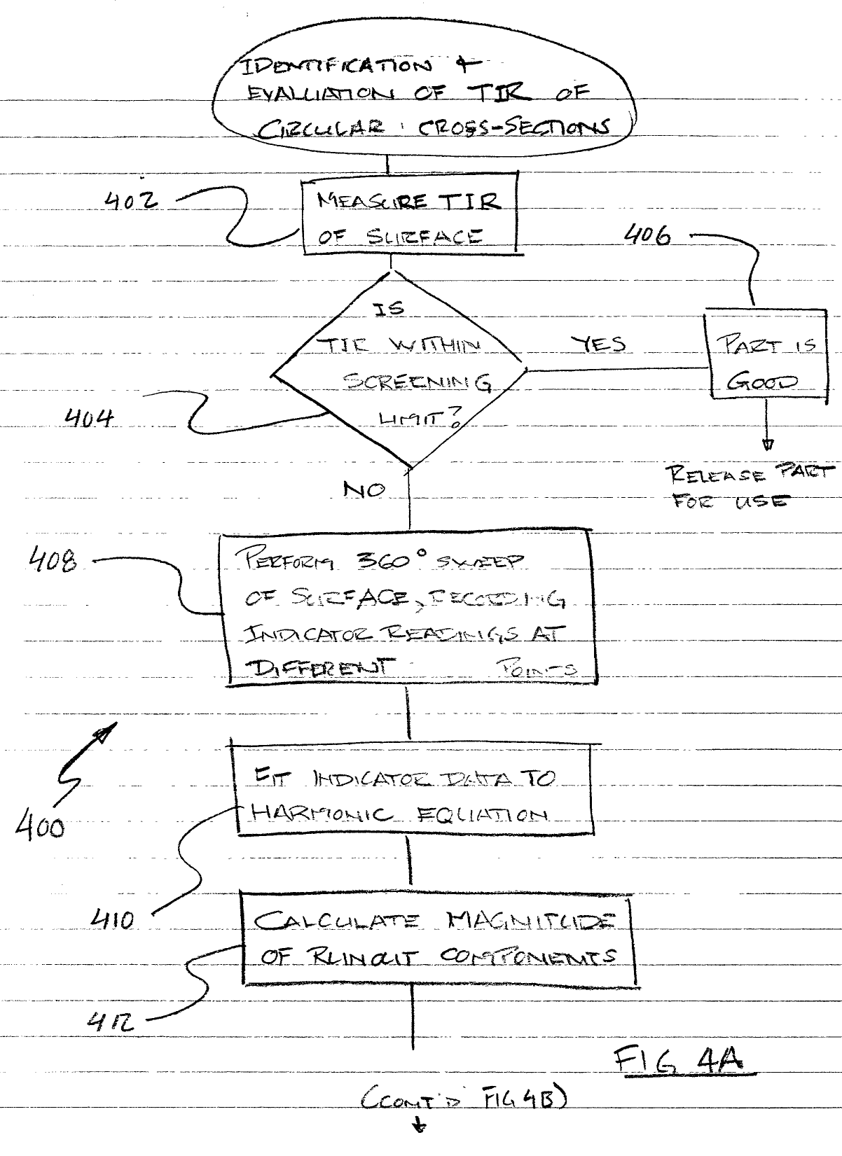

FIG. 3A is a side view of a cylindrical shaft 300 illustrating a twice-per-revolution (ellipticity) component of a TIR in accordance with an embodiment. The cylindrical shaft 300 is undergoing a dimensional inspection, and has a centroidal axis 320 and a rotational axis 302 that are aligned. The dial indicator 110 indicates a TIR 312 of a cylindrical surface 301 as the cylindrical shaft 300 rotates through 360° about the rotational axis 302. Assuming, for the purpose of illustration, that the centroidal axis 320 is coincident with the rotational axis 302, the TIR 312 will not in any way be attributable to an eccentricity component, but rather will be totally attributable to variations in the profile of the surface 301.

FIG. 3B is a cross-sectional view taken substantially along lines 3B-3B in FIG. 3A, and illustrates why the ellipticity component of the TIR can be identified as a twice-per-revolution component of the TIR. Since there is no eccentricity contribution to the TIR, an elliptical cross-section 303 is the sole contributor to the TIR 312. As the cylindrical shaft 300 rotates through one revolution of 360°, the peaks in the measured runout, identified by locations 304 and 305, will occur twice per revolution.

FIG. 3C is a graph 321 illustrating a plot 326 of a twice-per-revolution runout component of the cylindrical shaft 300, in accordance with an embodiment. A vertical axis 322 represents the measured runout, and a horizontal axis 324 represents the angle of rotation of the cylindrical shaft 300. The plot 326 graphically illustrates the runout as a function of the angle of rotation. A single revolution of the cylindrical shaft 300 is equivalent to the interval between 0 and 360° on the horizontal axis 324. The difference between the maximum and minimum runout measurements is equivalent to the TIR 312. As can be seen from the shape of the plot 326, the eccentricity component's contribution to the TIR 312 occurs twice per revolution. It should be noted that the magnitude of the TIR 212 in FIG. 2C and the magnitude of the TIR 312 in FIG. 3C can be equivalent, even though the two TIRs are attributable to two distinctly different phenomena, further emphasizing the importance of breaking a given TIR down into its individual components in order to fully understand the nature of the TIR. Consistent with the foregoing, a TIR of a cylindrical surface can also include a thrice-per-revolution component that is distinguishable from the once-per-revolution and twice-per-revolution components.

As a practical matter, a rotational component such as a cylindrical shaft will typically have separate and unique requirements for the individual runout components of eccentricity and ellipticity, even if these requirements are not explicitly specified. For example, a particular application may be able to tolerate a relatively large eccentricity component, but in contrast may require a relatively close tolerance surface profile, thereby requiring a relatively small ellipticity component. On the other hand, a particular application may be able to tolerate a relatively large ellipticity component, but in contrast may require close alignment between the component's centroidal axis and its rotational axis, thereby requiring a relatively small eccentricity component. Accordingly, allowable engineering limits for the eccentricity and ellipticity components of the TIR can be appropriately established for any given rotational component, depending on the application.

Conventional methods for dimensional inspection of rotating components often do not attempt to define allowable engineering limits for the individual components of the TIR. Instead, a single allowable TIR is usually selected that is essentially equivalent to the smaller of the allowable eccentricity or ellipticity components. As should be apparent from FIGS. 2A through 3B and the accompanying discussion, the TIR in fact can be comprised of a number of cumulative individual contributions, including principally the eccentricity and ellipticity components. As a result, rejecting a rotational component whose TIR exceeds an allowable limit established in the conventional manner, without first identifying and segregating the individual components of the TIR, may lead to rejection of some rotational components which may in fact be acceptable for their intended purpose. Conversely, further evaluation of the runout components using the methods disclosed herein, may have disclosed that although the total magnitude of the TIR exceeded the allowable limit for any one individual component, since the TIR was composed of two or more individual components, neither of those individual components actually exceeded its own allowable limit.

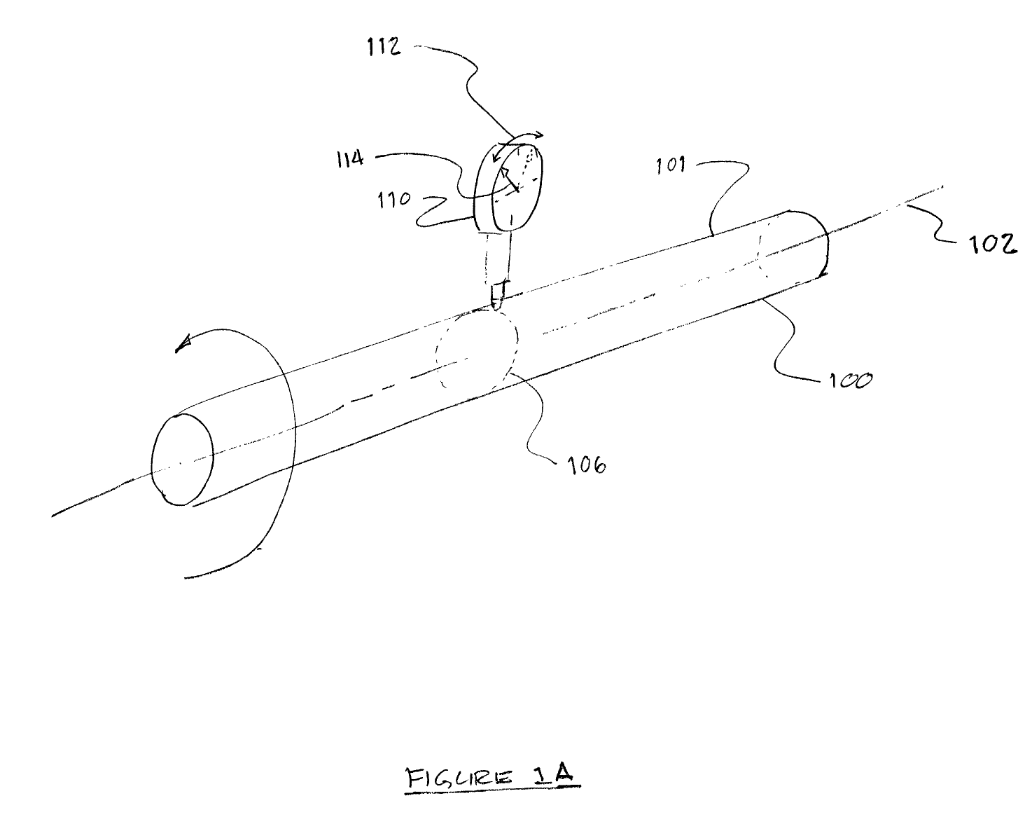

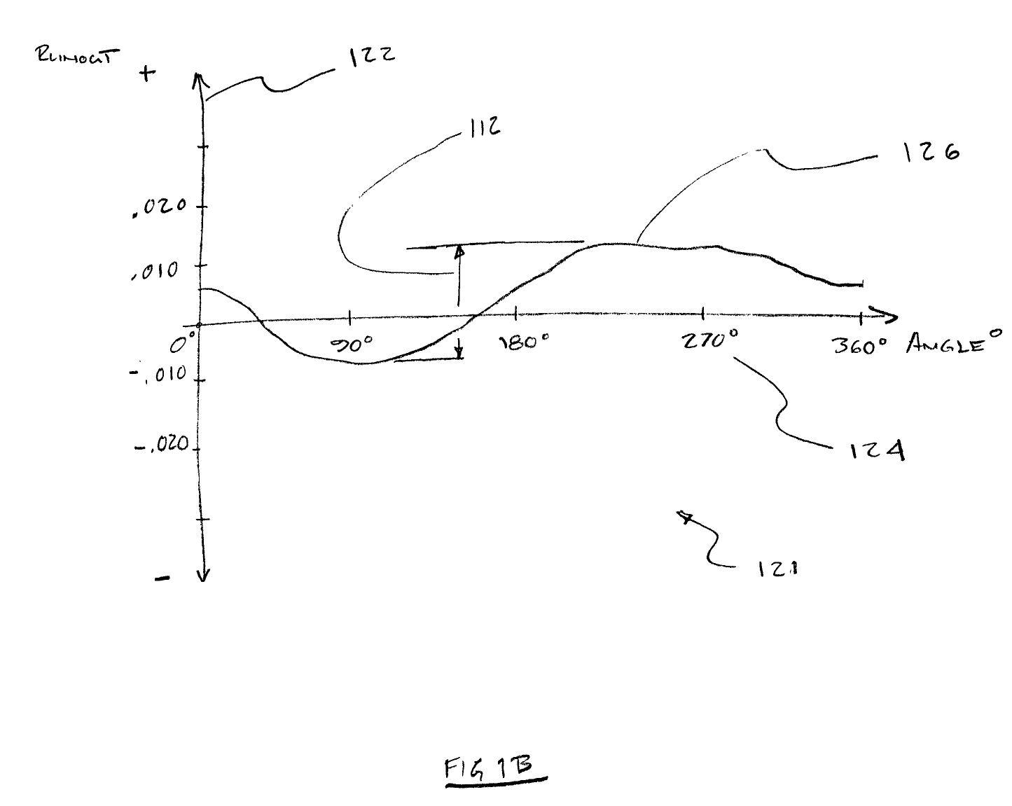

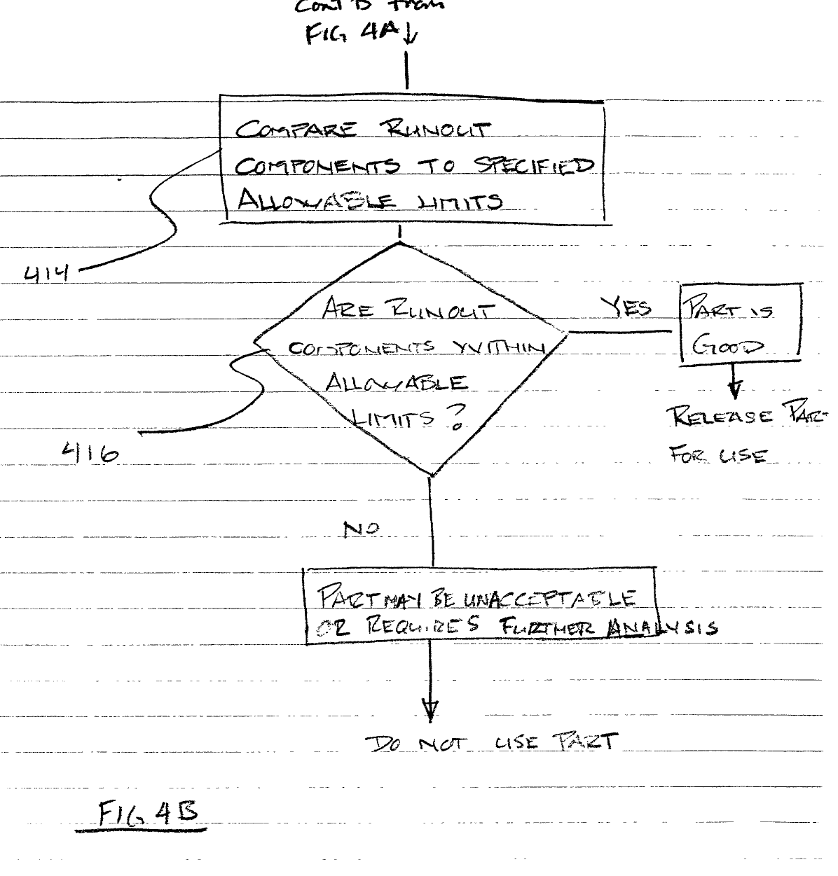

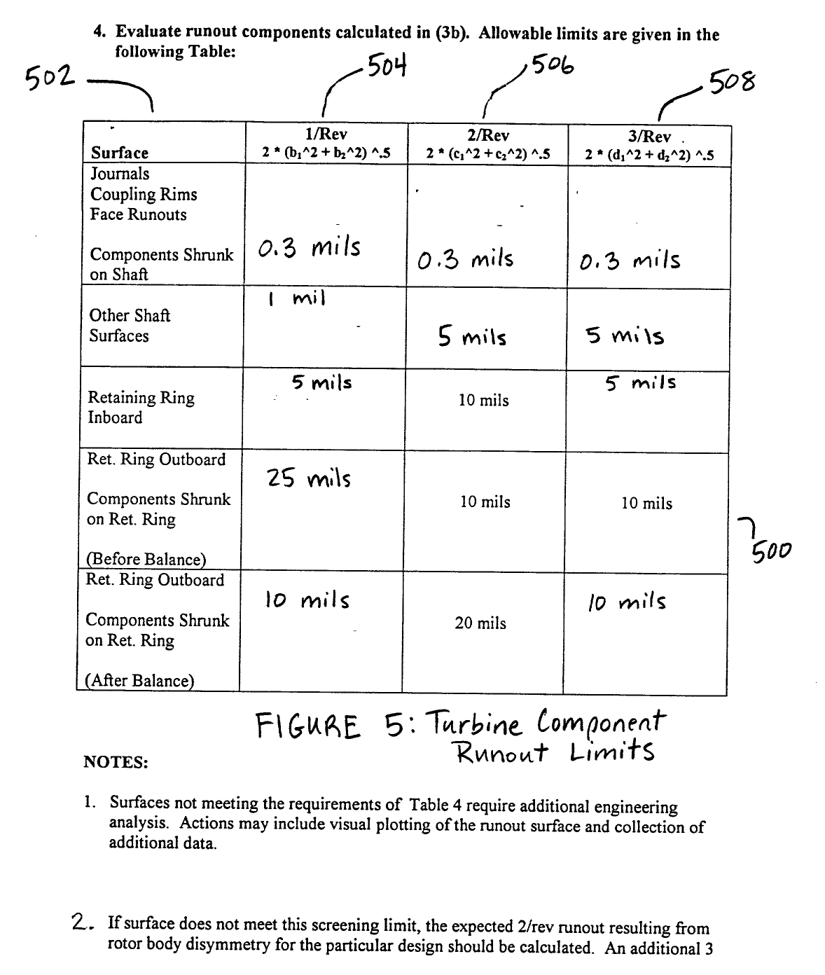

FIGS. 4A and 4B together illustrate a flow diagram of a routine 400 for identifying and evaluating individual components of a TIR in accordance with an embodiment. The routine of 400 can be performed using a general purpose computer with computer-executable instructions, or alternatively, the routine 400 can be performed using manual computations. Although the discussion that follows makes reference to the cylindrical shaft 100 shown in FIG. 1 for the purpose of illustration, the routine described is equally applicable to the inspection of any component where the determination of a cylindrical profile, or an axial alignment, is desired.

In block 402 of FIG. 4A, a TIR of the surface 101 at the station 106 (FIG. 1) is measured and recorded. There will necessarily be some value of TIR for the cylindrical shaft 100, below which the cylindrical shaft will unquestionably be dimensionally acceptable for its intended purpose. This TIR value can be defined as a screening limit. In block 404, if the TIR measured in block 402 is less than this screening limit, then the shaft 100 is accordingly deemed acceptable, and per block 406 no further evaluation is required. If the TIR measured in block 402 exceeds this screening limit, however, then the routine 400 proceeds to break the TIR down into its individual components so that the components may be individually evaluated.

In block 408, the routine 400 begins to break the TIR down into its individual components by first recording indicator readings at a plurality of different locations around the circumference of the surface 101 at the station 106 (FIG. 1). In one embodiment, the routine 400 records a set of 12 equally spaced indicator readings around the surface 101. The angular locations on the surface 101 corresponding to these indicator readings is also recorded. In other embodiments, indicator readings can be taken at more or less locations either equally or unequally spaced around the surface 101. In block 410, these indicator readings define data points which are fit to a third order harmonic equation shown below as equation (1):

y(x)=a+b₁ cos(x)+b₂ sin(x)+c₁ cos(2x)+c₂ sin(2x)+d₁ cos(3x)+d₂ sin(3x) (1)

In equation (1), y(x) is equal to an indicator reading and x is equal to the specific angular location associated with that reading. Evaluation of equation (1) at each of the indicator reading locations results in a separate equation for each location involving either some or all of the constants a, b₁, b₂, C₁, C₂, d₁, and d₂. The resulting equations can then be simultaneously solved using well-known methods to yield the values of these constants. Enough indicator readings should be taken around the surface 101 such that there will at least be enough simultaneous equations to solve for each constant. For example, if there are seven constants, then at least seven different indicator readings should be taken. In block 412, once the values of these constants are known, the magnitudes of the once-per-revolution (eccentricity), twice-per-revolution (ellipticity), and thrice-per-revolution components of the TIR can be calculated using equations (2), (3), and (4) below, respectively:

once-per-rev(eccentricity)component=2×\sqrt{(b₁²+b₂²)} (2)

twice-per-rev(ellipticity)component=2×\sqrt{(c₁²+c₂²)} (3)

thrice-per-rev component=2×\sqrt{(d₁²+d₂²)} (4)

Since the constant a in Equation (1) above is essentially a value that reflects the arbitrary offset of the dial indicator or other measuring device being used, it has no bearing on the magnitude of the individual runout components, and thus does not appear in Equations (2)-(4).

The method described above with reference to Equations (1)-(4) can be extended to other higher frequencies if identification of other runout components is desired. Extension to higher frequencies is analogous to the method described above. For example, if identification of a four-times-per-revolution component is desired, then Equation (1) above would include two additional terms of e₁ cos(4x) and e₂ sin(4x), and in the process would become a fourth order equation. The constants e₁ and e₂ can be found by using simultaneous equations as explained above. Similarly, the magnitude of the four-times-per-revolution runout component can then be calculated using Equation (5) below:

four-times-per-rev component=2×\sqrt{(e₁²+e₂²)} (5)

As the foregoing demonstrates, the harmonic Equation (1) can be extended to any frequency desired in accordance with the methods disclosed.

As will be appreciated by those of skill in the relevant art, the foregoing method for calculating the magnitude of the individual runout components can be used with other similar equations in addition to the harmonic equation (1) above. For example, in one embodiment the routine 400 can be performed using a Fast Fourier Transform. In other embodiments, other regression formulas that can be best fit to a series of runout data points to graphically illustrate the runout of a cylindrical cross-section can be used without departing from the scope of the present disclosure. In addition, it will also be appreciated that the harmonic equation (1) can also be modified depending on which TIR component is of interest. For example, if determining only a once-per-revolution component is of interest, then a first order equation can be used. Similarly, if determining only a twice-per-revolution component is of interest, then a second order equation can be used.

Departing from the routine 400 momentarily, FIG. 5 illustrates a table 500 of allowable runout limits for a number of exemplary turbine components, in accordance with an embodiment. The table 500 provides the allowable limit for each of the runout components calculated using equations (2)-(4), (i.e., for the once-, twice-, and thrice-per-rev runout components). The particular type of surface being inspected is listed in a column 502. For example, the representative surfaces of the turbine components include journal surfaces, coupling rims, shaft surfaces, and the surfaces of shrink fit components. The corresponding allowable limits of the once-per-revolution (eccentricity) component, the twice-per-revolution (ellipticity) component, and the thrice-per-rev component are listed in columns 504, 506, and 508, respectively. The values of the various runout component limits shown in table 500 will naturally vary depending on the significance of that particular characteristic to the function of the part in question.

In block 414 of FIG. 4B, the routine 400 compares the values of the individual runout components calculated in equations (2)-(4) to their respective limits. In one embodiment, these allowable limits can be included in a table similar to table 500 of FIG. 5. In block 416, if each of the runout components falls within its specified allowable limit, then the part is determined to be acceptable for its intended use. Conversely, if any of the individual runout components exceed their specified limits, the part may be unacceptable or require further engineering analysis.

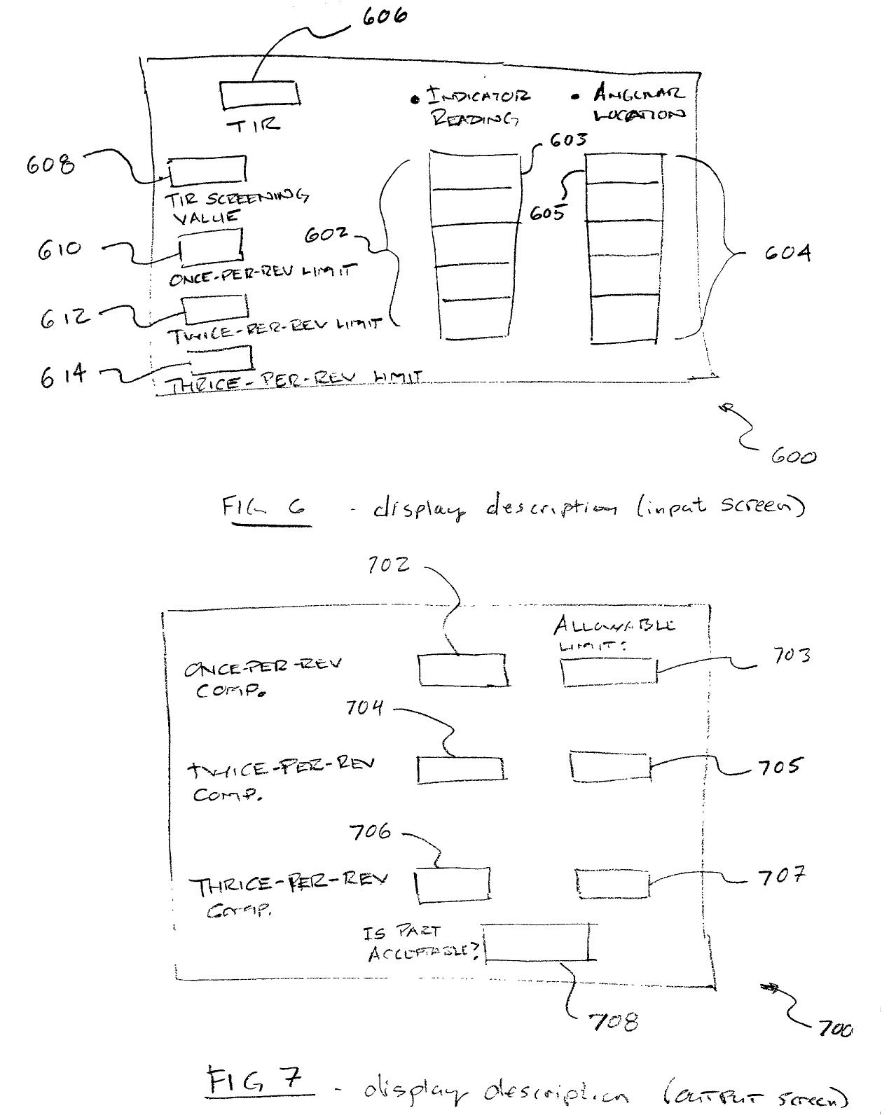

FIG. 6 illustrates a display description 600 for inputting the data points used to determine the components of a total indicated runout in accordance with an embodiment. In one aspect of this embodiment, the display description 600 can be displayed as a computer screen in which a user inputs the pertinent data. In another aspect, the display description 600 can be a web page. Importantly, the display description 600 includes an indicator reading portion 602 and an angular location portion 604. The indicator reading portion 602 contains a plurality of indicator reading fields for inputting runout measurements. The angular location portion 604 contains corresponding angular location fields for inputting the angular locations that correspond to the indicator readings. For example, the user could enter a runout measurement in an indicator reading field 603 and the angular location corresponding to the runout measurement in an angular location field 605. The display description 600 can optionally contain a TIR field 606 and a TIR screening value field 608, for inputting a TIR and a TIR screening value, respectively, that correspond to the particular circular cross-section of interest. The display description 600 can also optionally contain a once-, twice-, and thrice-per-revolution limit field 610, 612, and 614, respectively, for displaying the allowable limit values of the once-, twice-, and thrice-per-revolution components, respectively.

FIG. 7 illustrates a display description 700 for displaying determined values of total indicated runout components in accordance with an embodiment. In one aspect of this embodiment, the display description 700 can be displayed as a computer screen in which a user views the determined values. In another aspect, the display description 700 can be a web page. Importantly, the display description 700 includes a once-per-revolution-component field 702, a twice-per-revolution component field 704, and a thrice-per-revolution component field 706 for displaying the values of these components for the particular circular cross-section of interest. The display description 700 can also optionally contain corresponding allowable limit fields 703, 705, and 707 for displaying the allowable limits associated with each of these components. A part acceptability field 708 can also be optionally included in the display description 700 to indicate if the circular cross-section of interest exceeds any of its allowable runout component limits, and hence may be unacceptable for its intended use.

One advantage of using the routine 400 to identify and evaluate runout components for rotational parts, is that it may disclose those parts which actually meet their engineering requirements but would otherwise be rejected using conventional inspection methods. For precision rotational parts that require expensive raw materials and significant investment during the manufacturing phase, the benefits of the disclosed method can be significant. Referring once again to FIG. 1, a conventional inspection method would simply make one TIR measurement of the surface 101 at station 106, and compare this measurement to what is essentially equivalent to the conservative screening limit discussed above. If the part does not meet the screening limit, the part is rejected as being unacceptable. In contrast, the method disclosed herein would not stop there, but instead would proceed to segregate the TIR into its individual components to better understand the nature of the TIR. As is often the case, the TIR may be comprised of the cumulative effects of two or more components. When these components are segregated out and compared to their respective allowables, a part deemed rejectable using the conventional method may in fact prove perfectly acceptable.

The above description and illustrated embodiments of the analysis and evaluation method is not intended to be exhaustive or to limit the invention to the precise form disclosed. While specific embodiments of, and examples for, the invention are described herein for illustrative purposes, various equivalent modifications are possible within the scope of the invention, as those skilled in the relative art will recognize. For example, while the steps of the routine 400 involved a determination of the eccentricity, ellipticity, and thrice-per-revolution components of the TIR, the routine can be just as easily performed by only determining one of the relevant components where only that component is critical to the performance of the part in question. Further, the teachings of the embodiments provided herein for breaking a TIR down into its constituent elements, can be applied not only to rotational parts, but also to other parts where determination of similar characteristics is desired. Accordingly, the scope of the present invention is not limited except as by the appended claims.

We claim:

1. A method in a computer system for dimensionally evaluating a cross-section to determine if the cross-section is dimensionally acceptable for an intended use, the method comprising:
measuring a total indicated runout of the cross-section, the total indicated runout comprising a once-per-revolution component, a twice-per-revolution component, or a thrice-per-revolution component;
determining the magnitude of the once-per-revolution component, the twice-per-revolution component, or the thrice-per-revolution component; and
comparing the magnitude of the once-per-revolution component, the twice-per-revolution component, or the thrice-per-revolution component to a pre-selected limit to determine if the cross-section is dimensionally acceptable for the intended use.

2. The method of claim 1 further comprising:
comparing the total indicated runout to a screening value, wherein if the total indicated runout is less than or equal to the screening value, then the cross-section is dimensionally acceptable for the intended use, and wherein if the total indicated runout is greater than the screening value, then the cross-section may not be dimensionally acceptable for the intended use.

3. The method of claim 1 further comprising:
receiving data from the cross-section, the data comprising a plurality of individual runout measurements and the angular locations on the cross-section corresponding to the individual runout measurements.

4. The method of claim 1 wherein determining the magnitude of the once-per-revolution component, the twice-per-revolution component, or the thrice-per-revolution component comprises:
evaluating a regression equation comprising the summation or integration of a trigonometric function, the regression equation also comprising a variable corresponding to a runout measurement of the cross-section and a variable corresponding to the angular location of the runout measurement.

5. The method of claim 1 wherein the cross-section is a substantially circular cross-section.

6. A method in a computer system for dimensionally evaluating a cross-section to determine if the cross-section is dimensionally acceptable for an intended use, the method comprising:
measuring a total indicated runout of the cross-section, the total indicated runout comprising a once-per-revolution component, a twice-per-revolution component, or a thrice-per-revolution component;
comparing the total indicated runout to a screening value, wherein if the total indicated runout is less than or equal to the screening value, then the cross-section is dimensionally acceptable for the intended use, and wherein if the total indicated runout is greater than the screening value, then the cross-section may not be dimensionally acceptable for the intended use;
receiving data from the cross-section, the data comprising a plurality of individual runout measurements and the angular locations on the cross-section corresponding to the individual runout measurements;
representing the data using a regression equation comprising the summation or integration of a trigonometric function, the regression equation also comprising a variable corresponding to a runout measurement of the cross-section, a variable corresponding to the angular location of the runout measurement, and one or more constant terms;
determining the magnitude of the once-per-revolution component, the twice-per-revolution component, or the thrice-per-revolution component of the total indicated runout using one or more of the constant terms from the regression equation; and
comparing the magnitude of the once-per-revolution component, the twice-per-revolution component, or the thrice-per-revolution component to a pre-selected limit to determine if the cross-section is dimensionally acceptable for the intended use.

7. The method of claim 6 wherein the screening value is at least approximately equivalent to a pre-selected limit for the once-per-revolution component, the twice-per-revolution component, or the thrice-per-revolution component.

8. The method of claim 6 wherein receiving data from the cross-section comprises receiving runout measurements at a plurality of equally spaced angular locations around the cross-section.

9. The method of claim 6 wherein:
receiving data from the cross-section comprises receiving runout measurements at a plurality of equally spaced angular locations around the cross-section; and
representing the data using a regression equation comprises evaluating a harmonic equation using the runout measurements and the corresponding angular locations and solving a system of simultaneous equations for the constant terms in the harmonic equation.

10. The method of claim 9 wherein the harmonic equation is a third order harmonic equation.

11. The method of claim 6 wherein representing the data with a regression equation comprises representing the data with a Fast Fourier Transform.

12. The method of claim 6 wherein the cross-section is a substantially circular cross-section.

13. A computer-readable medium containing instructions for controlling a computer system to evaluate a cross-section by a method comprising:
receiving dimensional data from the cross-section, the dimensional data comprising a plurality of individual runout measurements and a plurality of angular locations on the cross-section corresponding to the individual runout measurements; and
determining the magnitude of a per-revolution component of a total indicated runout based on the dimensional data.

14. The computer-readable medium of claim 13 wherein the per-revolution component of the total indicated runout is a once-per-revolution component, a twice-per-revolution component, or a thrice-per-revolution component.

15. The computer-readable medium of claim 13 further comprising:
representing the dimensional data with a regression equation comprising the summation or integration of a trigonometric function, the regression equation also comprising a runout measurement variable, an angular location variable, and one or more constant terms; and wherein
determining the magnitude of the per-revolution component comprises using one or more of the constant terms from the regression equation.

16. The computer-readable medium of claim 13 further comprising:
comparing the magnitude of the per-revolution component to a pre-selected limit to evaluate the cross-section.

17. The computer-readable medium of claim 13 wherein the cross-section is a substantially circular cross-section.

18. A computer system for evaluating a total indicated runout of a cross-section, the total indicated runout comprising a once-per-revolution component, a twice-per-revolution component, or a thrice-per-revolution component, the computer system comprising:
means for receiving dimensional data from the cross-section, the dimensional data comprising a runout measurement and a corresponding angular location; and
means for determining the magnitude of the once-per-revolution component, the twice-per-revolution component, or the thrice-per-revolution component of the total indicated runout.

19. The computer system of claim 18 further comprising:
means for graphically displaying the once-per-revolution component, the twice-per-revolution component, or the thrice-per-revolution component of the total indicated runout as a function of angular location around the cross-section.

20. A method for dimensionally evaluating an at least substantially circular cross-section to determine if the cross-section is dimensionally acceptable for an intended use, the method comprising:
measuring a total indicated runout of the cross-section, the total indicated runout comprising a once-per-revolution component, a twice-per-revolution component, or a thrice-per-revolution component;
obtaining data from the cross-section comprising runout measurements at a plurality of different angular locations around the cross-section;
representing the data with a regression equation comprising a runout measurement variable, an angular location variable, and one or more constant terms;
determining the magnitude of the once-per-revolution component, the twice-per-revolution component, or the thrice-per-revolution component using one or more of the constant terms from the regression equation; and
comparing the magnitude of the once-per-revolution component, the twice-per-revolution component, or the thrice-per-revolution component to a pre-selected limit to determine if the cross-section is dimensionally acceptable for the intended use.

21. The method of claim 20 wherein:
obtaining data from the cross-section comprises receiving runout measurements at a plurality of equally spaced angular locations around the cross-section; and
representing the data using a regression equation comprises evaluating a third order harmonic equation using the runout measurements and the corresponding angular locations.

22. The method of claim 20 wherein representing the data with a regression equation comprises representing the data with a Fast Fourier Transform.

23. A method in a computer system for dimensionally evaluating a cross-section, the method comprising:
receiving dimensional data from the cross-section, the dimensional data comprising a plurality of individual runout measurements and a plurality of angular locations on the cross-section corresponding to the individual runout measurements; and
determining the magnitude of a per-revolution component of a total indicated runout based on the dimensional data.

24. The method of claim 23 wherein the cross-section is a substantially circular cross-section.

25. A display description for entering data for determining a once-per-revolution component, a twice-per-revolution component, or a thrice-per-revolution component of a total indicated runout of a cross-section, the display description comprising:
one or more indicated runout reading fields for entering indicated runout readings taken from around the cross-section; and
one or more angular location fields for entering angular locations that correspond to the one or more indicated runout readings.

26. A display description for displaying a once-per-revolution component, a twice-per-revolution component, and a thrice-per-revolution component of a total indicated runout of a cross-section, the display description comprising:
a once-per-revolution component field;
a twice-per-revolution component field,
a thrice-per-revolution component field; and
one or more allowable limit fields, the allowable limit fields displaying the corresponding allowable limits of the once-per-revolution component, the twice-per-revolution component, or the thrice-per-revolution component.

27. A computer-readable medium containing a data structure for determining a once-per-revolution component, a twice-per-revolution component, or a thrice-per-revolution component of a total indicated runout of a cross-section, the data structure comprising:
one or more individual runout measurements taken from around the cross-section; and
one or more angular locations corresponding to the one or more indicated runout measurements.
